(19) United States
(12) Patent Application Publication
(10) Pub. No.: US 2015/0306823 A1
(43) Pub. Date: Oct. 29, 2015

(54) MULTIPLE EXTRUSION IN THREE-DIMENSIONAL PRINTING

(71) Applicant: MakerBot Industries, LLC, Brooklyn, NY (US)

(72) Inventors: Andrew J. Askedall, Baldwin, NY (US); Joseph Neal, Riverside, CT (US)

(21) Appl. No.: 14/698,371

(22) Filed: Apr. 28, 2015

Related U.S. Application Data
(60) Provisional application No. 61/985,707, filed on Apr. 29, 2014.

(51) Int. Cl. B29C 67/00; B29C 47/92; B29C 47/06

(52) U.S. Cl. CPC B29C 67/0085; B29C 47/06; B29C 47/92; B29C 67/0055; B29C 67/0088; B29L 2031/772

(57) ABSTRACT

An extrusion assembly for a three-dimensional printer includes a plurality of extruders that can move independently relative to one another during a fabrication process. This permits concurrent extrusion over a variety of different tool paths, advantageously increasing the overall speed of fabrication. In general, the extrusion assembly as a whole may move within the x-y-z space of a build volume using conventional techniques, while one extruder is movable relative to the other, e.g., by moving radially about the other extruder in an x-y plane of the fabrication process or by moving in the z-axis of the fabrication process relative to the other extruder. Additional extruders may be usefully added to further increase the aggregate volume deposition rate in a three-dimensional fabrication process.

### CROSS-REFERENCE TO RELATED APPLICATIONS

This application claims the benefit of U.S. Prov. App. No. 61/985,707 filed on Apr. 29, 2014, the entire contents of which is hereby incorporated by reference.

### TECHNICAL FIELD

The disclosure relates to multiple extrusion in three-dimensional printing, and more specifically to three-dimensional printing with concurrent use of multiple extruders.

### BACKGROUND

There remains a need for improved extrusion assemblies capable of extruding from multiple extruders concurrently.

### SUMMARY

An extrusion assembly for a three-dimensional printer includes a plurality of extruders that can move independently relative to one another during a fabrication process. This permits concurrent extrusion over a variety of different tool paths, advantageously increasing the overall speed of fabrication. In general, the extrusion assembly as a whole may move within the x-y-z space of a build volume using conventional techniques, while one extruder is movable relative to the other, e.g., by moving radially about the other extruder in an x-y plane of the fabrication process or by moving in the z-axis of the fabrication process relative to the other extruder. Additional extruders may be usefully added to further increase the aggregate volume deposition rate in a three-dimensional fabrication process.

### BRIEF DESCRIPTION OF THE FIGURES

The foregoing and other objects, features and advantages of the devices, systems, and methods described herein will be apparent from the following description of particular embodiments thereof, as illustrated in the accompanying drawings. The drawings are not necessarily to scale, emphasis instead being placed upon illustrating the principles of the devices, systems, and methods described herein.

FIG. 1 is a block diagram of a three-dimensional printer.

FIG. 2 shows a perspective view of an extruder assembly.

FIG. 3 shows a perspective view of an extruder assembly in use.

FIG. 4 shows a top cross-sectional view of an extruder assembly.

FIG. 5 shows a top cross-sectional view of an extruder assembly.

FIG. 6 shows a front view of a three-dimensional printer.

FIG. 7 shows a method for three-dimensional printing with an extruder assembly having multiple extruders.

FIG. 8 shows a side view of a build plate with a plurality of feedpaths.

FIG. 9 shows a top view of a build plate with a plurality of feedpaths.

### DETAILED DESCRIPTION

The embodiments will now be described more fully hereinafter with reference to the accompanying figures, in which preferred embodiments are shown. The foregoing may, however, be embodied in many different forms and should not be construed as limited to the illustrated embodiments set forth herein.

All documents mentioned herein are hereby incorporated by reference in their entirety. References to items in the singular should be understood to include items in the plural, and vice versa, unless explicitly stated otherwise or clear from the text. Grammatical conjunctions are intended to express any and all disjunctive and conjunctive combinations of conjoined clauses, sentences, words, and the like, unless otherwise stated or clear from the context. Thus, the term “or” should generally be understood to mean “and/or” and so forth.

Recitation of ranges of values herein are not intended to be limiting, referring instead individually to any and all values falling within the range, unless otherwise indicated herein, and each separate value within such a range is incorporated into the specification as if it were individually recited herein. The words “about,” “approximately,” or the like, when accompanying a numerical value, are to be construed as indicating a deviation as would be appreciated by one of ordinary skill in the art to operate satisfactorily for an intended purpose. Ranges of values and/or numeric values are provided herein as examples only, and do not constitute a limitation on the scope of the described embodiments. The use of any and all examples, or exemplary language (“e.g.,” “such as,” or the like) provided herein, is intended merely to better illuminate the embodiments and does not pose a limitation on the scope of the embodiments. No language in the specification should be construed as indicating any unclaimed element as essential to the practice of the embodiments.

In the following description, it is understood that terms such as “first,” “second,” “top,” “bottom,” “above,” “below,” and the like, are words of convenience and are not to be construed as limiting terms.

The following description emphasizes three-dimensional printers using fused deposition modeling or similar techniques where a bead of material is extruded in a layered series of two dimensional patterns as “roads,” “paths,” or the like to form a three-dimensional object from a digital model. It will be understood, however, that numerous additive fabrication techniques are known in the art including without limitation multijet printing, stereolithography, Digital Light Processor (“DLP”) three-dimensional printing, selective laser sintering, and so forth. Such techniques may benefit from the systems and methods described below, and all such printing technologies are intended to fall within the scope of this disclosure, and within the scope of terms such as “printer,” “three-dimensional printer,” “fabrication system,” and so forth, unless a more specific meaning is explicitly provided or otherwise clear from the context.

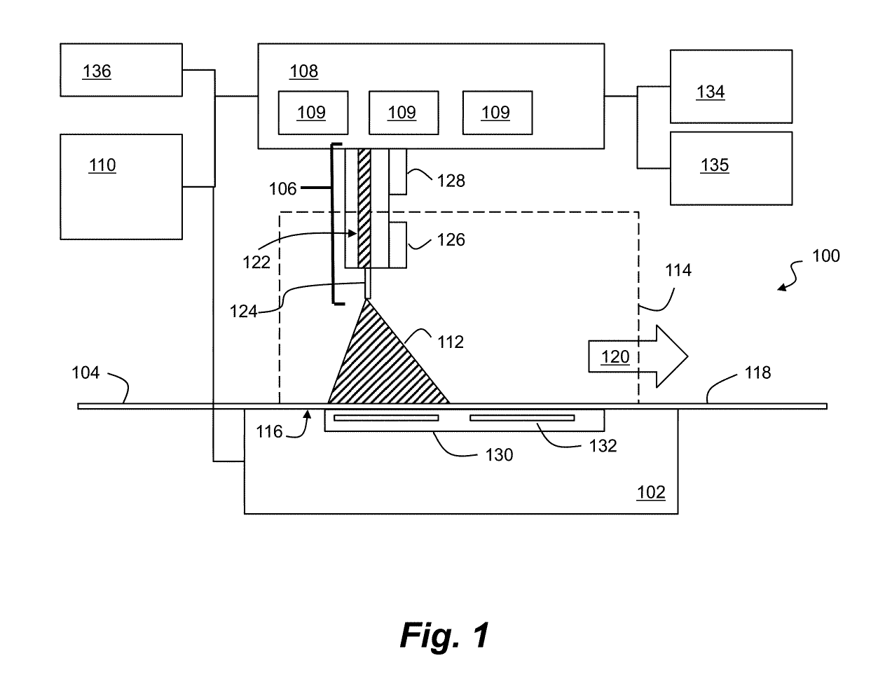

FIG. 1 is a block diagram of a three-dimensional printer. In general, the printer 100 may include a build platform 102, a conveyor 104, an extruder 106, an x-y-z positioning assembly 108, and a controller 110 that cooperate to fabricate an object 112 within a working volume 114 of the printer 100.

The build platform 102 may include a surface 116 that is rigid and substantially planar. The surface 116 may support the conveyer 104 in order to provide a fixed, dimensionally and positionally stable platform on which to build the object 112.

The build platform 102 may include a thermal element 130 that controls the temperature of the build platform 102 through one or more active devices 132 such as resistive elements that convert electrical current into heat, Peltier effect devices that can create a heating or cooling effect, or any other thermoelectric heating and/or cooling devices. Thus the thermal element 130 may be a heating element that provides active heating to the build platform 102, a cooling element that provides active cooling to the build platform 102, or a combination of these. The heating element 130 may be coupled in a communicating relationship with the controller 110 in order for the controller 110 to controllably impart heat to or remove heat from the surface 116 of the build platform 102. Thus the thermal element 130 may include an active cooling element positioned within or adjacent to the build platform 102 to controllably cool the build platform 102.

It will be understood that a variety of other techniques may be employed to control a temperature of the build platform 102. For example, the build platform 102 may use a gas cooling or gas heating device such as a vacuum chamber or the like in an interior thereof, which may be quickly pressurized to heat the build platform 102 or vacated to cool the build platform 102 as desired. As another example, a stream of heated or cooled gas may be applied directly to the build platform 102 before, during, and/or after a build process. Any device or combination of devices suitable for controlling a temperature of the build platform 102 may be adapted to use as the thermal element 130 described herein.

The conveyer 104 may be formed of a sheet 118 of material that moves in a path 120 through the working volume 114. Within the working volume 114, the path 120 may pass proximal to the surface 116 of the build platform 102—that is, resting directly on or otherwise supported by the surface 116—in order to provide a rigid, positionally stable working surface for a build. It will be understood that while the path 120 is depicted as a unidirectional arrow, the path 120 may be bidirectional, such that the conveyer 104 can move in either of two opposing directions through the working volume 114. It will also be understood that the path 120 may curve in any of a variety of ways, such as by looping underneath and around the build platform 102, over and/or under rollers, or around delivery and take up spools for the sheet 118 of material. Thus, while the path 120 may be generally (but not necessarily) uniform through the working volume 114, the conveyer 104 may move in any direction suitable for moving completed items from the working volume 114. The conveyor may include a motor or other similar drive mechanism (not shown) coupled to the controller 110 to control movement of the sheet 118 of material along the path 120. Various drive mechanisms are shown and described in further detail below.

In general, the sheet 118 may be formed of a flexible material such as a mesh material, a polyamide, a polyethylene terephthalate (commercially available in bi-axial form as MYLAR), a polyimide film (commercially available as KAPTON), or any other suitably strong polymer or other material. The sheet 118 may have a thickness of about three to seven thousandths of an inch, or any other thickness that permits the sheet 118 to follow the path 120 of the conveyer 104. For example, with sufficiently strong material, the sheet 118 may have a thickness of one to three thousandths of an inch. The sheet 118 may instead be formed of sections of rigid material joined by flexible links.

A working surface of the sheet 118 (e.g., an area on the top surface of the sheet 118 within the working volume 114) may be treated in a variety of manners to assist with adhesion of build material to the surface 118 and/or removal of completed objects from the surface 118. For example, the working surface may be abraded or otherwise textured (e.g., with grooves, protrusions, and the like) to improve adhesion between the working surface and the build material.

A variety of chemical treatments may be used on the working surface of the sheet 118 of material to further facilitate build processes as described herein. For example, the chemical treatment may include a deposition of material that can be chemically removed from the conveyer 104 by use of water, solvents, or the like. This may facilitate separation of a completed object from the conveyer by dissolving the layer of chemical treatment between the object 112 and the conveyor 104. The chemical treatments may include deposition of a material that easily separates from the conveyer such as a wax, mild adhesive, or the like. The chemical treatment may include a detachable surface such as an adhesive that is sprayed on to the conveyer 104 prior to fabrication of the object 112.

In one aspect, the conveyer 104 may be formed of a sheet of disposable, one-use material that is fed from a dispenser and consumed with each successive build.

In one aspect, the conveyer 104 may include a number of different working areas with different surface treatments adapted for different build materials or processes. For example, different areas may have different textures (smooth, abraded, grooved, etc.). Different areas may be formed of different materials. Different areas may also have or receive different chemical treatments. Thus a single conveyer 104 may be used in a variety of different build processes by selecting the various working areas as needed or desired.

The extruder 106 may include a chamber 122 in an interior thereof to receive a build material. The build material may, for example, include acrylonitrile butadiene styrene (“ABS”), high-density polyethylene (“HDPL”), polylactic acid, or any other suitable plastic, thermoplastic, or other material that can usefully be extruded to form a three-dimensional object. The extruder 106 may include an extrusion tip 124 or other opening that includes an exit port with a circular, oval, slotted or other cross-sectional profile that extrudes build material in a desired cross-sectional shape.

The extruder 106 may include a heater 126 to melt thermoplastic or other meltable build materials within the chamber 122 for extrusion through an extrusion tip 124 in liquid form. While illustrated in block form, it will be understood that the heater 126 may include, e.g., coils of resistive wire wrapped about the extruder 106, one or more heating blocks with resistive elements to heat the extruder 106 with applied current, an inductive heater, or any other arrangement of heating elements suitable for creating heat within the chamber 122 to melt the build material for extrusion. The extruder 106 may also or instead include a motor 128 or the like to push the build material into the chamber 122 and/or through the extrusion tip 124.

In general operation (and by way of example rather than limitation), a build material such as ABS plastic in filament form may be fed into the chamber 122 from a spool or the like by the motor 128, melted by the heater 126, and extruded from the extrusion tip 124. By controlling a rate of the motor 128, the temperature of the heater 126, and/or other process parameters, the build material may be extruded at a controlled volumetric rate. It will be understood that a variety of techniques may also or instead be employed to deliver build material at a controlled volumetric rate, which may depend upon the type of build material, the volumetric rate desired, and any other factors. All such techniques that might be suitably adapted to delivery of build material for fabrication of a three-dimensional object are intended to fall within the scope of this disclosure. As noted above, other techniques may be employed for three-dimensional printing, including extrusion-based techniques using a build material that is curable and/or a build material of sufficient viscosity to retain shape after extrusion.

The x-y-z positioning assembly 108 may generally be adapted to three-dimensionally position the extruder 106 and the extrusion tip 124 within the working volume 114. Thus by controlling the volumetric rate of delivery for the build material and the x, y, z position of the extrusion tip 124, the object 112 may be fabricated in three dimensions by depositing successive layers of material in two-dimensional patterns derived, for example, from cross-sections of a computer model or other computerized representation of the object 112. A variety of arrangements and techniques are known in the art to achieve controlled linear movement along one or more axes. The x-y-z positioning assembly 108 may, for example, include a number of stepper motors 109 to independently control a position of the extruder within the working volume along each of an x-axis, a y-axis, and a z-axis. More generally, the x-y-z positioning assembly 108 may include without limitation various combinations of stepper motors, encoded DC motors, gears, belts, pulleys, worm gears, threads, and so forth. Any such arrangement suitable for controllably positioning the extruder 106 within the working volume 114 may be adapted to use with the printer 100 described herein.

By way of example and not limitation, the conveyor 104 may be affixed to a bed that provides x-y positioning within the plane of the conveyor 104, while the extruder 106 can be independently moved along a z-axis. As another example, the extruder 106 may be stationary while the conveyor 104 is x, y, and z positionable. As another example, the extruder 106 may be x, y, and z positionable while the conveyer 104 remains fixed (relative to the working volume 114). In yet another example, the conveyer 104 may, by movement of the sheet 118 of material, control movement in one axis (e.g., the y-axis), while the extruder 106 moves in the z-axis as well as one axis in the plane of the sheet 118. Thus in one aspect, the conveyor 104 may be attached to and move with at least one of an x-axis stage (that controls movement along the x-axis), a y-axis stage (that controls movement along a y-axis), and a z-axis stage (that controls movement along a z-axis) of the x-y-z positioning assembly 108. More generally, any arrangement of motors and other hardware controllable by the controller 110 may serve as the x-y-z positioning assembly 108 in the printer 100 described herein. Still more generally, while an x, y, z coordinate system serves as a convenient basis for positioning within three dimensions, any other coordinate system or combination of coordinate systems may also or instead be employed, such as a positional controller and assembly that operates according to cylindrical or spherical coordinates.

The controller 110 may be electrically coupled in a communicating relationship with the build platform 102, the conveyer 104, the x-y-z positioning assembly 108, and the other various components of the printer 100. In general, the controller 110 is operable to control the components of the printer 100, such as the build platform 102, the conveyer 104, the x-y-z positioning assembly 108, and any other components of the printer 100 described herein to fabricate the object 112 from the build material. The controller 110 may include any combination of software and/or processing circuitry suitable for controlling the various components of the printer 100 described herein including without limitation microprocessors, microcontrollers, application-specific integrated circuits, programmable gate arrays, and any other digital and/or analog components, as well as combinations of the foregoing, along with inputs and outputs for transceiving control signals, drive signals, power signals, sensor signals, and so forth. In one aspect, the controller 110 may include a microprocessor or other processing circuitry with sufficient computational power to provide related functions such as executing an operating system, providing a graphical user interface (e.g., to a display coupled to the controller 110 or printer 100), convert three-dimensional models into tool instructions, and operate a web server or otherwise host remote users and/or activity through the network interface 136 described below.

A variety of additional sensors may be usefully incorporated into the printer 100 described above. These are generically depicted as sensor 134 in FIG. 1, for which the positioning and mechanical/electrical interconnections with other elements of the printer 100 will depend upon the type and purpose of the sensor 134 and will be readily understood and appreciated by one of ordinary skill in the art. The sensor 134 may include a temperature sensor positioned to sense a temperature of the surface of the build platform 102. This may, for example, include a thermistor or the like embedded within or attached below the surface of the build platform 102. This may also or instead include an infrared detector or the like directed at the surface 116 of the build platform 102 or the sheet 118 of material of the conveyer 104. Other sensors that may be usefully incorporated into the printer 100 as the sensor 134 include a heat sensor, a volume flow rate sensor, a weight sensor, a sound sensor, and a light sensor. Certain more specific examples are provided below by way of example and not of limitation.

The sensor 134 may include a sensor to detect a presence (or absence) of the object 112 at a predetermined location on the conveyer 104. This may include an optical detector arranged in a beam-breaking configuration to sense the presence of the object 112 at a location such as an end of the conveyer 104. This may also or instead include an imaging device and image processing circuitry to capture an image of the working volume 114 and analyze the image to evaluate a position of the object 112. This sensor 134 may be used for example to ensure that the object 112 is removed from the conveyor 104 prior to beginning a new build at that location on the working surface such as the surface 116 of the build platform 102. Thus the sensor 134 may be used to determine whether an object is present that should not be, or to detect when an object is absent. The feedback from this sensor 134 may be used by the controller 110 to issue processing interrupts or otherwise control operation of the printer 100.

The sensor 134 may include a sensor that detects a position of the conveyer 104 along the path. This information may be obtained from an encoder in a motor that drives the conveyer 104, or using any other suitable technique such as a visual sensor and corresponding fiducials (e.g., visible patterns, holes, or areas with opaque, specular, transparent, or otherwise detectable marking) on the sheet 118.

The sensor 134 may include a heater (instead of or in addition to the thermal element 130) to heat the working volume 114 such as a radiant heater or forced hot air to maintain the object 112 at a fixed, elevated temperature throughout a build. The sensor 134 may also or instead include a cooling element to maintain the object 112 at a predetermined sub-ambient temperature throughout a build.

The sensor 134 may also or instead include at least one video camera. The video camera may generally capture images of the working volume 114, the object 112, or any other hardware associated with the printer 100. The video camera may provide a remote video feed through the network interface 136, which feed may be available to remote users through a user interface maintained by, e.g., remote hardware such as a three-dimensional print server, or within a web page provided by a web server hosted by the three-dimensional printer 100. Thus in one aspect there is disclosed herein a user interface adapted to present a video feed from at least one video camera of a three-dimensional printer to a remote user through a user interface.

The sensor 134 may also include more complex sensing and processing systems or subsystems, such as a three-dimensional scanner using optical techniques (e.g., stereoscopic imaging, or shape from motion imaging), structured light techniques, or any other suitable sensing and processing hardware that might extract three-dimensional information from the working volume 114. In another aspect, the sensor 134 may include a machine vision system that captures images and analyzes image content to obtain information about the status of a job, working volume 114, or an object 112 therein. The machine vision system may support a variety of imaging-based automatic inspection, process control, and/or robotic guidance functions for the three-dimensional printer 100 including without limitation pass/fail decisions, error detection (and corresponding audible or visual alerts), shape detection, position detection, orientation detection, collision avoidance, and so forth.

Other components, generically depicted as other hardware 135, may also be included, such as input devices including a keyboard, touchpad, mouse, switches, dials, buttons, motion sensors, and the like, as well as output devices such as a display, a speaker or other audio transducer, light emitting diodes, and so forth. Other hardware 135 may also or instead include a variety of cable connections and/or hardware adapters for connecting to, e.g., external computers, external hardware, external instrumentation or data acquisition systems, and so forth.

The printer 100 may include, or be connected in a communicating relationship with, a network interface 136. The network interface 136 may include any combination of hardware and software suitable for coupling the controller 110 and other components of the printer 100 to a remote computer in a communicating relationship through a data network. By way of example and not limitation, this may include electronics for a wired or wireless Ethernet connection operating according to the IEEE 802.11 standard (or any variation thereof), or any other short or long range wireless networking components or the like. This may include hardware for short range data communications such as BlueTooth or an infrared transceiver, which may be used to couple into a local area network or the like that is in turn coupled to a data network such as the Internet. This may also or instead include hardware/software for a WiMax connection or a cellular network connection (using, e.g., CDMA, GSM, LTE, or any other suitable protocol or combination of protocols). Consistently, the controller 110 may be configured to control participation by the printer 100 in any network to which the network interface 136 is connected, such as by autonomously connecting to the network to retrieve printable content, or responding to a remote request for status or availability.

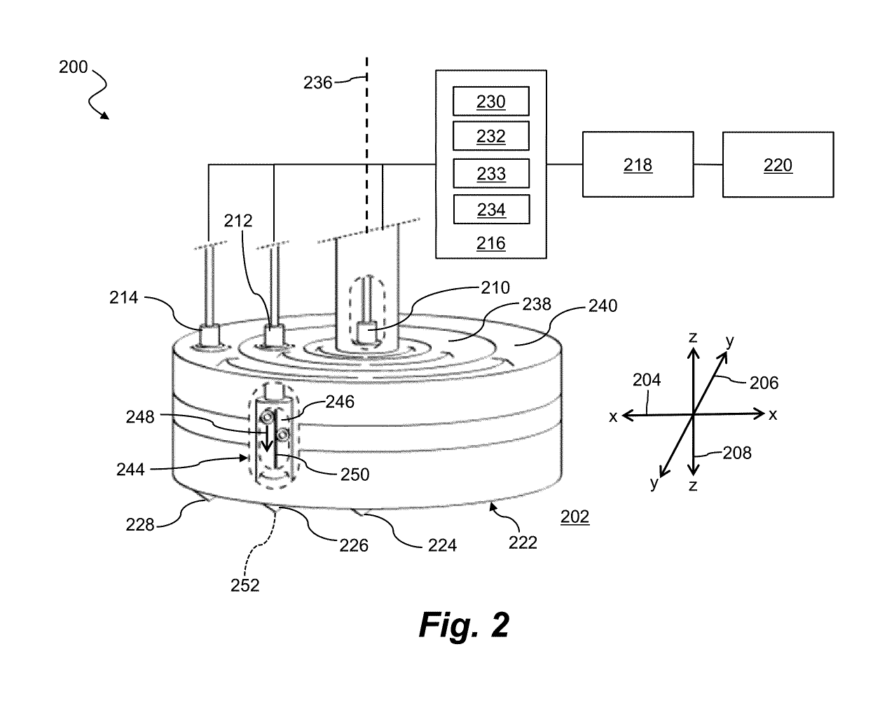

FIG. 2 shows a perspective view of an extruder assembly. In general, the extruder assembly 200 may include a plurality of extruders that can move independently relative to one another during a fabrication process, e.g., the fabrication of a three-dimensional object using a three-dimensional printer. In this manner, the extruder assembly 200 may permit concurrent extrusion of build material(s) from the plurality of extruders over a variety of different tool paths, advantageously increasing the overall speed of fabrication of an object, and allowing for the fabrication of intricate patterns and complex shapes otherwise unavailable in traditional extrusion assemblies.

The extruder assembly 200 may be included as part of a three-dimensional printer, such as any as described herein. For example, the extruder assembly 200 may be adapted such that it can be placed for use within a standard three-dimensional printer with only minor modifications, e.g., it may include a modular system that can be removed and replaced within a three-dimensional printer. It may also or instead be possible for the plurality of extruders to be modularly attached together to form the extruder assembly 200, or to be inserted into the extrusion assembly 200, e.g., where one or more of the plurality of extruders are removable and replaceable.

In general, the extruder assembly 200 may be movable as a whole within a build volume 202 of a three-dimensional printer, i.e., along one or more of the x-axis 204, the y-axis 206, and the z-axis 208 within the build volume 202, such as by using any of the x-y-z position systems described above. At the same time, one or more of the plurality of extruders included therein may be movable independent of the whole extruder assembly 200.

As shown in FIG. 2, the extruder assembly 200 may include a plurality of extruders, such as a first extruder 210, a second extruder 212, and a third extruder 214. A person of ordinary skill will recognize that more or less extruders are also possible, and implementations are not limited to those shown in the accompanying figures. The extruder assembly 200 may also include a positioning system 216, a controller 218, a processor 220, and an extrusion head 222 integrating the several extruders into a single, multi-extruder device.

The first extruder 210 may be configured to extrude a first build material. The first build material may be any material commonly used in three-dimensional printing including without limitation thermoplastics (e.g., PLA, ABS, HIPS, nylon, and so on), high-density polyethylene (HDPE), metals, edible materials, rubber, ceramics, silicone, and so forth, or any other material contemplated in the art for fabrication of a three-dimensional object. The first build material may come in a variety of sizes and shapes, e.g., filament form, pellets, liquid, and so forth. The first build material may be used for extrusion from any or all of the plurality of extruders in the extruder assembly 200, or one or more of the plurality of extruders may extrude different build materials. The first build material may be provided to the first extruder 210 through the use of one or more material supplies associated with a three-dimensional printing system that includes the extruder assembly 200. The supply of the first build material may be an independent supply for the first extruder 210 or it may be a shared supply of material with one or more of the plurality of extruders included in the extruder assembly 200.

The first extruder 210 may include an extruder as discussed with reference to FIG. 1, or any other extruder that is adapted to be used in an extruder assembly 200 as contemplated herein. For example, the first extruder 210 may include its own motor or the like to push a build material into its chamber and through a first extrusion nozzle 224. Similarly, the other extruders included in the extruder assembly 200 (e.g., the second extruder 212, third extruder 214, and so on) may also or instead include an extruder as discussed herein with reference to FIG. 1, or any other extruder that is adapted to be used in an extruder assembly 200 as contemplated herein. Further, the other extruders included in the extruder assembly 200 (e.g., the second extruder 212, third extruder 214, and so on) may include their own motor or the like to push the build material into their chamber and through extrusion nozzles (e.g., a second extrusion nozzle 226, a third extrusion nozzle 228, and so on).

The first extruder 210 may be stationary within the extruder assembly 200 (i.e., it maintains its x-y-z position relative to the extruder assembly 200 as a whole), or movable relative to the extrusion head 222 and/or the other plurality of extruders (e.g., the second extruder 212, the third extruder 214, and so forth).

In an implementation where the first extruder 210 maintains its x-y-z position relative to the extruder assembly 200, the first extruder 210 may move with the extruder assembly 200 as the positioning system 216 moves the extruder assembly 200 as a whole. In this manner, the first extruder 210 is led in the same path through the build volume 202 during a three-dimensional fabrication process as the extruder assembly 200 as a whole. In such an implementation, the first extruder 210 thus includes similar movement to that of current extruders known in the art, and may be used in isolation as a conventional, single extruder. In an aspect, while the first extruder 210 remains stationary within the extrusion head 222, the other extruders included within the extruder assembly 200 are movable relative to the first extruder 210. In certain aspects, regardless of whether the first extruder 210 is movable within the extruder assembly 200 or whether it maintains its x-y-z position within the extruder assembly 200, the first extruder 210 may be able to rotate about its central axis. In other aspects, the first extruder 210 is in a fixed position relative to an x-y-z positioning system, such as on an axis such as the central axis 236 at the center of a number of concentric rings that are used to radially position other extruders about the axis. That is, the first extruder 210 may move in lockstep with the printer's positioning system, while other extruders move relative to the first extruder 210.

In an implementation, the first extruder 210 is movable relative to the extrusion head 222 and the other extruders. For example, the first extruder 210 may be movable in the x-y plane, or along one or more of the x-axis 204, y-axis 206, and the z-axis 208.

The second extruder 212 may be configured to extrude a second build material concurrently with the first extruder 210. The second extruder 212 may also or instead extrude the second build material concurrently with another one (or more) of the plurality of extruders included in the extruder assembly 200. One skilled in the art will understand that the second extruder 212, or any of the other extruders included in the extruder assembly 200, may instead extrude the second build material independently of one or more of the other extruders included in the extruder assembly 200 (i.e., the second extruder 212, third extruder 214, and so on, may be configured to extrude a build material concurrently or non-concurrently with one or more of the other extruders). Thus, in an aspect, the first extruder 210, second extruder 212, and third extruder 214 can each extrude material independently from one another.

The second build material may be the same type of build material as the first build material, or it may be a different type of build material. Similarly, the second build material may be associated with its own independent supply of material for the second extruder 212, or the second build material may be associated with a shared supply of material with one or more of the plurality of extruders included in the extruder assembly 200.

The second extruder 212, or any of the other extruders included in the extruder assembly 200, may be movable about the first extruder 210 in an x-y plane of the build volume 202. In this manner, the second extruder 212 may extrude the second build material concurrently with one or more of the plurality of extruders, but along a different feedpath such as an adjacent, parallel path, a leading or following path, or an independent path. In another aspect, the second extruder 212 may extrude the second build material along the same feedpath as one or more of the plurality of extruders, but at a different position, i.e., to the left or right of the feedpath (which position may change as the direction of the feedpath changes) or trailing behind the feedpath of another extruder at a different z-axis position (or depositing build material ahead of another extruder that follows the feedpath of the second extruder 212). The second extruder 212 may also or instead be movable about any of the other extruders included in the extruder assembly 200 (e.g., the third extruder 214) in an x-y plane of the build volume 202. Similarly, the z-axis of the second extruder 212, or any other extruder included in the extruder assembly 200, may be movable relative any of the other extruders included in the extruder assembly 200 (e.g., the third extruder 214).

The third extruder 214 may be configured to extrude a third build material concurrently with at least one of the first extruder 210 and the second extruder 212. As discussed above, the third extruder 214 may instead extrude the third build material independently of one or more of the other extruders included in the extruder assembly 200. The third build material may be the same as the first build material and/or the second build material, or it may be a different build material. Similarly, the third build material may be associated with its own independent supply of material for the third extruder 214, or the third build material may be associated with a shared supply of material with one or more of the plurality of extruders included in the extruder assembly 200.

The third extruder 214 may be movable within the x-y plane relative to the first extruder 210, and/or relative to one or more of the other extruders included in the extruder assembly 200. For example, the third extruder 214 may be movable relative to the second extruder 212.

Movement of the extruders included in the extruder assembly 200 in the x-y plane may be radial movement about an axis, e.g., radial movement about a central axis 236 of the extrusion head 222. For example, the extruders may be coupled to a number of concentric, cylindrical fixtures that are mechanized to rotate about an axis independently of one another. Movement of the extruders included in the extruder assembly 200 in the x-y plane may also or instead include radial movement about the first extruder 210. The radial movement of the extruders may occur at a fixed distance relative to one another. Thus, in an aspect, the second extruder 212 or the third extruder 214 (or both) may be radially movable at a fixed distance about the first extruder 210. In an embodiment where the first extruder 210 is movable in the x-y plane, the first extruder 210 may be radially movable around a central axis 236 of the extrusion head 222. In another embodiment, movement of the extruders in the x-y plane may be independent (unfixed) relative to an axis or the other extruders.

The extruders included in the extruder assembly 200, e.g., the first extruder 210, the second extruder 212, the third extruder 214, and so on, may also or instead be movable in the z-axis 208. Movement of the extruders in the z-axis 208 may be relative to one or more of the other extruders included in the extruder assembly 200. Movement of the extruders in the z-axis 208 may also or instead be relative to the extrusion head 222, a frame of the three-dimensional printer, or another reference point of interest. In an aspect, both the second extruder 212 and the third extruder 214 have a variable z-axis position within the build volume 202 relative to the first extruder 210.

In another aspect, one or more of the extruders included in the extruder assembly 200 (e.g., the first extruder 210, the second extruder 212, the third extruder 214, and so on) may have fixed z-axis positions. For example, in an aspect, the second extruder 212 has a fixed z-axis position within the build volume 202 relative to the first extruder 210. The fixed z-axis position may be equal to a second z-axis position of the first extruder 210. Alternatively, the fixed z-axis position may be different than a second z-axis position of the first extruder 210, e.g., the fixed z-axis position may be disposed above the second z-axis position in the build volume 202.

In a similar manner, the third extruder 214 may have a fixed z-axis position within the build volume 202 relative to one or more of the first extruder 210 and the second extruder 212. The fixed z-axis position may be equal to the z-axis position of one or more of the other extruders included in the extruder assembly 200, or it may be different than the z-axis position of one or more of the other extruders. For example, the fixed z-axis position of the third extruder 214 may be disposed above the z-axis position of the second extruder 212, which is disposed above the z-axis position of the first extruder 210. Arranging different fixed z-axis positions of the extruders in the extruder assembly 200 may be advantageous for allowing for the deposition of multiple layers of build material at the same time, i.e., layered building of an object during fabrication. Alternatively, having one or more extruders in an extruder assembly at the same z-axis positions can allow for the building of complex patterns, e.g., infill patterns, without slowing the extruder assembly 200. The z-axis position of each extruder can be set manually or automatically based on slicing or the like.

The positioning system 216 may be configured to move the extrusion head 222 in a path through the build volume 202 during a three-dimensional fabrication process. Thus, in an embodiment where the first extruder 210 is stationary within the extrusion head 222, the positioning system 216 is configured to move the first extruder 210 in a path through the build volume 202 during a three-dimensional fabrication process. The positioning system 216 may thus be the same or similar to the x-y-z positioning assembly discussed above with reference to FIG. 1. In one aspect, the positioning system 216 includes a gantry movement system or similar for moving the extrusion head 222 through the build volume 202.

The positioning system 216 may include additional mechanical elements for not only moving the extrusion head 222 through the build volume 202, but also moving one or more of the extruders included in the extruder assembly 200 independently of the movement of the extrusion head 222. For example, each extruder included in the extruder assembly 200, e.g., the first extruder 210, the second extruder 212, and the third extruder 214, may include its own stepper motor (or plurality of stepper motors) or the like, and associated components (e.g., gears, belts, pulleys, actuators, and so forth), to independently control a position of the particular individual extruder along each of the x-axis 204, y-axis 206, and z-axis 208 relative to the extrusion head 222 and/or one or more of the other extruders. In an aspect, the positioning system 216 includes a plurality of actuators for positioning the extruder assembly 200 and the plurality of extruders included therein. For example, linear actuators may position the extruder assembly 200 as a whole, while radial actuators 234 radially position one or more of the plurality of extruders in the x-y plane relative to one another (or relative to the extrusion head 222). In this manner, the positioning system 216 may include a linear x-axis actuator 230 and a linear y-axis actuator 232, where the second extruder 212 is movable about the first extruder 210 radially in the x-y plane using a radial actuator 234. The positioning system 216 may also or instead include a linear z-axis actuator 233.

The controller 218 maybe electrically coupled in a communicating relationship with the positioning system 216, or with one or more positioners/devices for the extruder assembly 200. The controller 218 may be programmed to control the operation of one or more of the extrusion head 222 (e.g., through control of the positioning system 216), the first extruder 210, the second extruder 212, the third extruder 214, and so forth, in a three-dimensional fabrication process. The controller 218 may be the same or similar to that discussed above with reference to FIG. 1, and may include any combination of software and/or processing circuitry suitable for controlling the various components of the extruder assembly 200 or the three-dimensional printing system. For example, the controller may include a processor 220.

In one aspect, the controller 218 is configured to move the second extruder 212 relative to the first extruder 210 in the x-y plane according to a path of the three-dimensional fabrication process (i.e., the path taken by the extrusion head 222 and/or the first extruder 210 in the three-dimensional fabrication process).

The controller 218 may be programmed to avoid entanglement along feedpaths of the plurality of extruders included in the extruder assembly 200, e.g., the first extruder 210, the second extruder 212, and the third extruder 214.

The processor 220 may be configured to generate a path for fabricating an object in the build volume using the extruders included in the extruder assembly 200, e.g., the first extruder 210, the second extruder 212, and the third extruder 214.

The controller 218 and the processor 220 may work together to move the plurality of extruders included in the extruder assembly 200 in a coordinated fashion. The controller 218 and the processor 220 may be under manual or automatic control, e.g., for movement of the plurality of extruders along one or more of the x-axis 204, the y-axis 206, and the z-axis. For example, in one aspect, the second extruder 212 can move in the z-axis 208 relative to the first extruder 210 under control of the controller 218, where the processor 220 receives a manual user specification of a z-axis offset for the second extruder 212 relative to the first extruder 210. In another aspect, the second extruder 212 can move in the z-axis 208 relative to the first extruder 210 under control of the controller 218, where the processor 220 automatically determines a z-axis offset for the second extruder 212 relative to the first extruder 210. One skilled in the art will recognize that these are merely two examples of many possible controls and configurations for controlling the plurality of extruders in the extruder assembly 200.

As discussed above, the z-axis position of each extruder can be set automatically, or adjusted manually by a user, e.g., using three-dimensional printing software. In one aspect, a slicer engine can maximize the speed of the extruder assembly 200 moving through the build volume 202 while finer adjustments are made with rotating stepper motors or the like. Other implementations for creating advanced toolpaths for the extruder assembly 200 are also or instead possible.

The extrusion head 222 may house the extruders included in the extruder assembly 200, e.g., the first extruder 210, the second extruder 212, and the third extruder 214. As shown in the figure, the extrusion head 222 may be configured such that one or more of the plurality of extruders included in the extruder assembly 200 is radially movable in the x-y plane within the extrusion head 222. In this manner, the extrusion head 222 can be considered a rotating mechanical system in an embodiment. For example, in the figure, the extrusion head 222 is substantially disk-shaped and includes one or more tracks or paths for the extruders to move about the central axis 236 of the extrusion head 222. The tracks or paths may include substantially concentric rings such that one or more of the extruders orbits outward from the central axis 236 within the ring. In this manner, the extrusion head 222 can provide for an orbital extrusion system. Specifically, in one aspect, the second extruder 212 may be radially movable in the in the x-y plane within the extrusion head 222 along the second track 238 about the central axis 236 (and the first extruder 210). Similarly, the third extruder 214 may be radially movable in the in the x-y plane within the extrusion head 222 along the third track 240 about the central axis 236 (and the first extruder 210). Although the figure shows only one extruder per track, a track or path may instead include a plurality of extruders.

The extrusion head 222 may also be shaped and sized such that one or more of the plurality of extruders are removable and replaceable within the extruder assembly 200.

FIG. 2 further shows a section 244 through the extrusion head 222 and into the second extruder 212. As shown by this section 244, one or more of the extruders may include an interior 246 providing a feedpath 248 for the build material 250. The extruder may also include a nozzle (e.g., the second extrusion nozzle 226) with an opening 252 shaped to extrude the build material 250. Thus, for example, in an extruder assembly 200 having at least two extruders, the extruder assembly 200 can include a first extruder 210 having a first interior providing a first feedpath for a first build material and a first extrusion nozzle 224 with a first opening shaped to extrude the first build material, and a second extruder 212 having a second interior providing a second feedpath for a second build material and a second extrusion nozzle 226 with a second opening shaped to extrude the second build material.

An embodiment includes a positioning mechanism that is configured to position the nozzles of the extruder assembly 200, e.g., the first extrusion nozzle 224, the second extrusion nozzle 226, and the third extrusion nozzle 228. For example, in one aspect, the positioning mechanism is configured to move the second extrusion nozzle 226 relative to the first extrusion nozzle 224 during a fabrication process with the first extruder 210 and the second extruder 212. The nozzles may be configured for similar movement to that discussed above for the plurality of extruders. For example, the positioning mechanism may be configured to move the second extrusion nozzle 226 radially about the first extrusion nozzle 224 in an x-y plane of the build volume 202 when the extruder assembly 200 is placed for use in a three-dimensional printer. By way of another example, the positioning mechanism may also or instead be configured to move the second extrusion nozzle 226 in a z-axis of the fabrication process relative to the first extrusion nozzle 224.

The positioning mechanism may be part of the positioning system 216 discussed above, and include any of the features of the positioning system 216. For example, the positioning mechanism may also or instead be controlled by the controller 218, e.g., for moving the second extruder 212 relative to the first extruder 210 during fabrication of an object.

The plurality of extruders in the extruder assembly 200 may be able to fabricate separate objects concurrently, different parts of the same object concurrently, or the same part of an object concurrently. For example, in one aspect, different extruders each build a different aspect of the same object, e.g., one builds a shell while the other builds a raft.

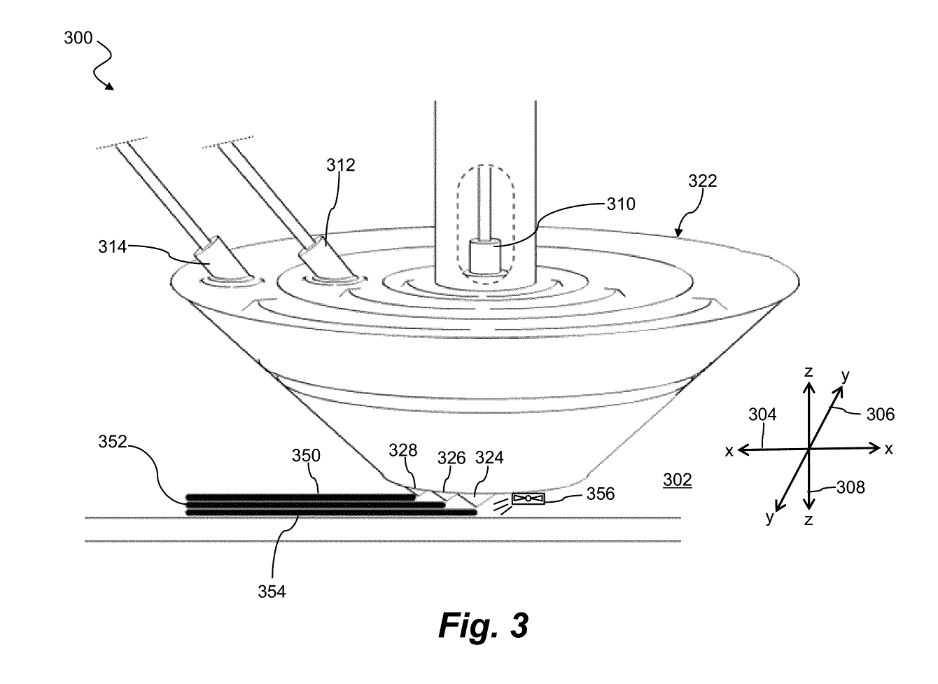

FIG. 3 shows a perspective view of an extruder assembly in use. Similar to the assembly described above, the extruder assembly 300 may include an extrusion head 322 having a first extruder 310, a second extruder 312, and a third extruder 314, where the extruder assembly 300 as a whole can traverse within a build volume 302 along an x-axis 304, a y-axis 306, and a z-axis 308.

Although similar to the assembly described above, the extrusion head 322 of the extruder assembly 300 may include a different shape and configuration. Specifically, the extrusion head 322 may have a substantially cone-shaped design or otherwise be shaped such that the nozzles converge in a relatively close proximity. In this manner, the nozzles (e.g., the first extrusion nozzle 324, the second extrusion nozzle 326, and the third extrusion nozzle 328), which may be heated during an extrusion process, can maintain relative confinement of the heat created or they can share heating elements. Also, this configuration may allow for the drive mechanisms of the extruders to have ample space within the extrusion head 322.

The extruder assembly 300 may also include staggered z-axis positions for the plurality of extruders included therein, e.g., the first extruder 310, the second extruder 312, and the third extruder 314. The staggered heights of the plurality of extruders may allow for the deposition of multiple layers of build material at the same time. For example, as shown in the figure, the first extrusion nozzle 324 is disposed at a first z-axis position, the second extrusion nozzle 326 is disposed at a second z-axis position that is located above the first z-axis position, and the third extrusion nozzle 328 is disposed at a third z-axis position that is located above both the first z-axis position and the second z-axis position. In this manner, the extruder assembly 300 can allow for the concurrent extrusion of: a first build material 350 along a first feedpath at the first z-axis position; a second build material 352 along a second feedpath at the second z-axis position, i.e., directly above the first feedpath; and a third build material 354 along a third feedpath at the third z-axis position, i.e., directly above the second feedpath. Other configurations of the extruders are possible, where the staggering and arrangement of the extruders provides for other advantages that will be apparent to one skilled in the art.

To provide for printing successive layers of build material concurrently on top of one another, the extruder assembly 300 may include an active cooling system 356. The active cooling system 356 may be operable to cool one or more layers of material deposited by one or more of the plurality of extruders included in the extruder assembly 300. For example, in one aspect, the active cooling system 356 cools a first layer of material (e.g., the first build material 350) deposited by the first extruder 310 in a first path (e.g., the first feedpath) before receiving a second layer of material (e.g., the second build material 352) from the second extruder 312 in a second path (e.g., the second feedpath), where the second path is disposed directly above the first path. In this manner, the active cooling system 356 may apply a cooling effect on the build material as it leaves a nozzle (e.g., the first extrusion nozzle 324) in order for the next layer of build material to be successfully deposited on top of the previous layer, i.e., without build materials oozing into each other during a build. One skilled in the art will recognize that this is just one example of how an active cooling system 356 can be used in an extruder assembly 300 as contemplated herein.

The active cooling system 356 may include any means known in the art for cooling a build material including without limitation fans, blowers, and so forth.

In one aspect, the plurality of extruders are offset by approximately 0.30 mm each, which can allow for a 0.90 mm layer height to print substantially concurrently when three extruders are used. In another aspect, e.g., for finer detail, a 0.10 mm offset can be used. One skilled in the art will recognize that these are merely exemplary, and the z-axis offsets capable in the systems contemplated herein are only limited by the size and configuration of the mechanical substructures.

The ability to deposit concurrent, multiple layers during a three-dimensional fabrication process can allow for the use of multiple materials at once. This can be advantageous for, e.g., dissolvable supports, or using flexible materials that can be staggered for builds having layers of elasticity. Other advantages will be apparent to those skilled in the art.

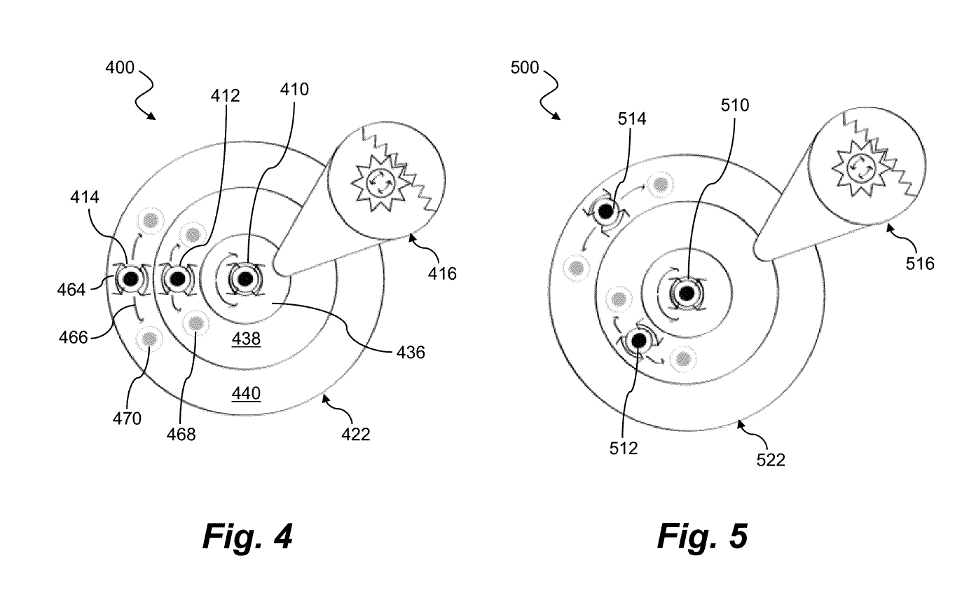

FIG. 4 shows a top cross-sectional view of an extruder assembly, i.e., through the x-y plane. The extruder assembly 400 may include an extrusion head 422 having a plurality of extruders, e.g., a first extruder 410, a second extruder 412, and a third extruder 414. The extruder assembly 400 may further include one or more positioning mechanisms 416 for moving one or more of the extruders relative to another extruder, or for generally moving an extruder about the extrusion head 422.

As shown in the figure, the first extruder 410 may be disposed substantially in the center of the extrusion head 422, with the other extruders are disposed radially outward at fixed distances. Specifically, the second extruder 412 may be disposed radially outward from the first extruder 410, where the third extruder 414 is disposed radially outward from both the second extruder 412 and the first extruder 410. Each of the plurality of extruders may be configured for rotation within the extrusion head 422 as indicated by the rotational arrows 464. Also, one or more of the plurality of extruders may be configured for independent movement (e.g., radial movement) about one another within the extrusion head 422 as indicated by the radial arrows 466. For example, the second extruder 412 may be movable about the first extruder 410, e.g., into the various second extruder positions 468 shown. Further, the third extruder 414 may be movable about the first extruder 410, e.g., into the various third extruder positions 470 shown. One of ordinary skill will recognize that these positions are provided by way of example only, and many other positions about the first extruder 410 are possible.

To facilitate movement of one or more of the plurality of extruders in the extruder assembly 400, the extrusion head 422 may include a plurality of rings or tracks, e.g., a first track 436, a second track 438, and a third track 440. The rings or tracks may each include one or more extruders such that movement of the rings or tracks about the extrusion head 422 provides movement of the extruders included therein. For example, as shown in the figure, the second track 438 includes the second extruder 412 and the third track 440 includes the third extruder 414. The rings or tracks may maintain radial alignment of the plurality of extruders, e.g., such that the extruders can move about the extrusion head 422 along a fixed radial path. For example, the second extruder 412 and the third extruder 414 may orbit the first extruder 410 along their respective tracks. In another embodiment, movement of the extruders in the x-y plane may be fixed relative to another shape or pattern about the first extruder 410 or another axis (e.g., the extruders may form a polygonal pattern about an axis). The rings or tracks may cooperate with one another through any means known in the art, including without limitation, gears, belts, threads, and so forth. This cooperation may allow for the rings or tracks to share a positioning mechanism 416. Alternatively, each ring or track may include its own positioning mechanism 416. Moving a ring or track in the extrusion head 422 may cause movement of another ring or track. Alternatively, the rings or tracks may be independently movable relative to one another.

The positioning mechanism 416 may include a stepper motor or the like having appropriate mechanical elements for moving the rings or tracks. In this manner, the positioning mechanism 416 may move the rings or tracks that are holding an extruder thereby moving the extruder about the extrusion head 422. In the example shown in the figure, both the second extruder 412 and the third extruder 414 can move radially about the first extruder 410, which may occur together or independently. The movement of one or more of the plurality of extruders may account for the positioning of other extruders within the extrusion head 422 such that the extruder assembly 400 avoids tangling (or other interference, e.g., friction, breakage, and so on) of the build material being fed into or out of the extruders.

FIG. 5 shows a top cross-sectional view of an extruder assembly, i.e., through the x-y plane. Specifically, FIG. 5 shows alternate positions of a first extruder 510, a second extruder 512, and a third extruder 514 within the extrusion head 522 of the extruder assembly 500. Similar to the embodiment described above, the extruder assembly 500 may include one or more positioning mechanisms 516 for moving one or more of the extruders relative to another extruder, or for generally moving an extruder about the extrusion head 522.

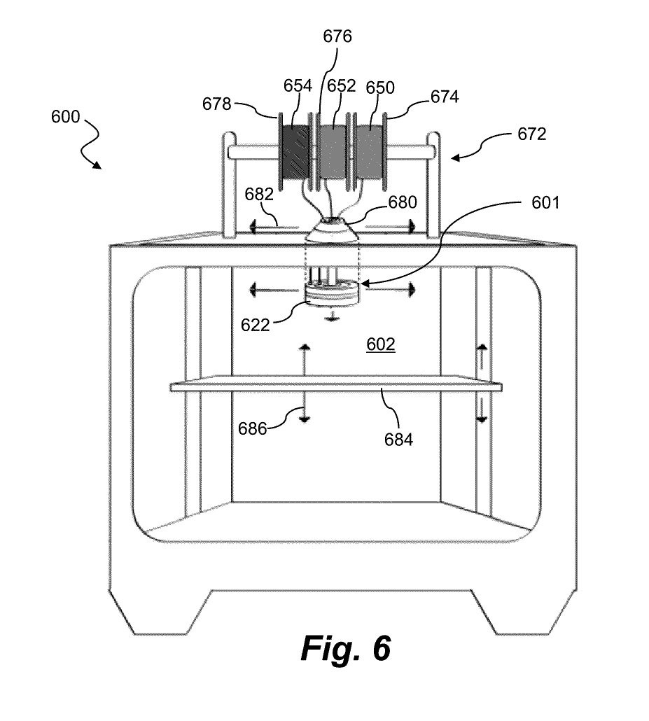

FIG. 6 shows a front view of a three-dimensional printer. The three-dimensional printer 600 may include an extruder assembly 601 as contemplated herein, i.e., where the extruder assembly 601 includes a plurality of extruders that can move independently relative to one another or independently relative to an extrusion head 622 of the extruder assembly 601. Additionally, the extruder assembly 601 as a whole may move within the build volume 602 of the three-dimensional printer 600, i.e., along one or more of the x-axis, the y-axis, and the z-axis. Movement of the extruder assembly 601 as a whole in the x-y-z space of the build volume may be accomplished using a positioning system, which can include any known, conventional techniques such as gantry systems and the like. Within the extruder assembly 601, one extruder may be movable relative to another extruder, e.g., by moving radially about the other extruder in an x-y plane and/or by moving in the z-axis relative to the other extruder.

The three-dimensional printer 600 may include a building material supply system 672, which can include one or more supplies of build material for the plurality of extruders included in the extruder assembly 601. Each supply of build material may include one or more build materials that can be used for extrusion in a three-dimensional printing process.

As shown in the figure, the building material supply system 672 may include a first supply 674 of a first build material 650 where the first supply 674 is coupled to a first extruder, a second supply 676 of a second build material 652 where the second supply 676 is coupled to a second extruder, and a third supply 678 of a third build material 654 where the third supply 678 is coupled to a third extruder. As shown in the figure, the build materials may come in filament form, where the filament is fed into the top of the extruder assembly 601.

The building material supply system 672 may work in conjunction with the positioning system 616, or otherwise with an assembly 680 (e.g., a build material coordination assembly, such as a filament or cabling assembly), such that, as the positioning system moves the extruder assembly 601, the build material does not become tangled, break, undergo unwanted friction, or otherwise does not facilitate free movement of the extruder assembly 601 through the build volume 602. For example, the assembly 680 may move in the x-y plane with the extruder assembly 601 as indicated by the arrows 682.

The three-dimensional printer 600 may include a build plate 684. The build plate 684 may be positioned at the bottom of the build volume 602 to receive an object fabricated during a three-dimensional fabrication process. The build plate 684 may be movable within the build volume 602 as indicated by the arrows 686.

In one aspect, the positioning system for the extruder assembly 601 of the three-dimensional printer 600 moves the extruder assembly 601 linearly (i.e., in a substantially straight line) in the x-y plane during a build. In this manner, complex patterns and shapes may still be fabricated through the use of the movable extruders included therein. In other words, the extruder assembly 601 as contemplated herein can allow for the creation of intricate patterns by depositing build material with the whole extruder assembly 601 moving in a substantially straight line at a predetermined speed while the movable extruders (e.g., rotating extruders) fabricate complex shapes moving radially about the extrusion head 622. Additionally, at the same time, one or more fixed extruders in the extruder assembly 601 may be depositing build material, e.g., in a substantially straight line.

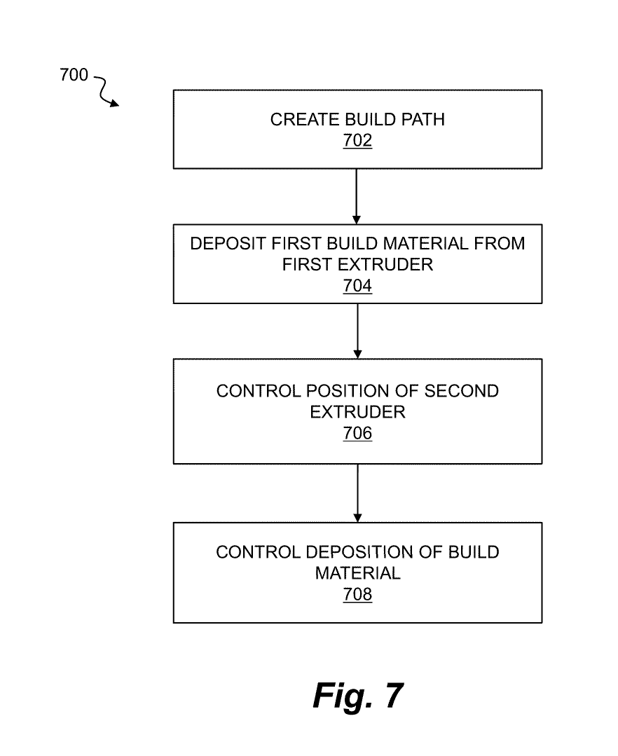

FIG. 7 shows a method for three-dimensional printing with an extruder assembly having multiple extruders. The extruder assembly with multiple extruders may be any as described above or otherwise herein, e.g., one having multiple, independently movable extruders for concurrent extrusion over a variety of different toolpaths, advantageously increasing the overall speed of fabrication, and allowing for the creation of intricate patterns in a fabrication process.

As shown in step 702, the method 700 may include creating a build path for the extruders included in an extruder assembly having multiple extruders. The build path may be created to best utilize multiple concurrent extrusion, e.g., using a path generation algorithm or other path generation tools adapted specifically to account for multiple, concurrently depositing extruders. It will be understood that tool paths for multiple concurrent extrusion may require additional handling. For example, while some patterns such as recurring infill geometries and multi-shelled exterior walls present trivial path modification issues, other geometries require additional handling, and in some instances it may not be possible to concurrently extrude with two or more extruders. Additionally, an extruder having multiple feedpaths may impose additional constraints, such as entanglement of several different filament feeds, and a path generation algorithm should also account for changes in the relative orientation of the incoming filament lines during a fabrication process. Resolving these and other issues is well within the ordinary skill in the art, but may require modifications to prior art path generation tools in order to best take advantage of multiple concurrent extruders and avoid problems due to, e.g., entangling of physical feedpaths or incursion into a path previously printed at a different z-axis position.

As shown in step 704, the method 700 may include depositing a first build material from a first extruder in a first path during a three-dimensional fabrication process. As discussed herein, the first extruder may be fixed within an extruder assembly with multiple extruders, or the first extruder may be movable within the extruder assembly. Other extruders may move relative to the first extruder in an extruder assembly with multiple extruders.

As shown in step 706, the method 700 may include controlling a position of a second extruder about the first extruder, e.g., in an x-y plane of the three-dimensional fabrication process. This step 706 may also or instead include controlling a z-axis position of the second extruder relative to the first extruder. Controlling the position of the second extruder may include the use of a controller to move the second extruder relative to the first extruder during the three-dimensional fabrication process. Controlling the position of the second extruder may be automatic or manual. Movement of the second extruder may include radial movement about the first extruder, and/or moving the second extruder in the z-axis relative to the first extruder during the three-dimensional fabrication process.

As shown in step 708, the method 700 may include controlling the deposition of the build material. Controlling the deposition of the build material may include depositing a second build material from the second extruder in a second path in the three-dimensional fabrication process substantially concurrently with depositing the first build material in the first path. Controlling the deposition of the build material may instead include depositing the second build material non-concurrently with the depositing of the first build material.

In one aspect, depositing the second build material from the second extruder in the second path occurs at the same z-axis position as the deposition of the first build material in the first path. In another aspect, depositing the second build material from the second extruder in the second path occurs at a different z-axis position as the deposition of the first build material in the first path.

Controlling the deposition of the build material may include stopping depositing the second build material while continuing depositing the first build material at some point during the three-dimensional fabrication process. Controlling the deposition of the build material may instead include stopping depositing the first build material while continuing depositing the second build material at some point during the three-dimensional fabrication process. Thus, controlling the deposition of the build material may be orchestrated in a variety of ways, particularly in embodiments with more than two extruders, and all such orchestrations and embodiments are intended to fall within the scope of this disclosure.

The devices, systems, methods, and techniques described herein (e.g., the method 700 discussed above) can be expanded to include any number of extruders, and any version of x-axis, y-axis, and/or z-axis control of one or more of the extruders relative to one or more of the other extruders.

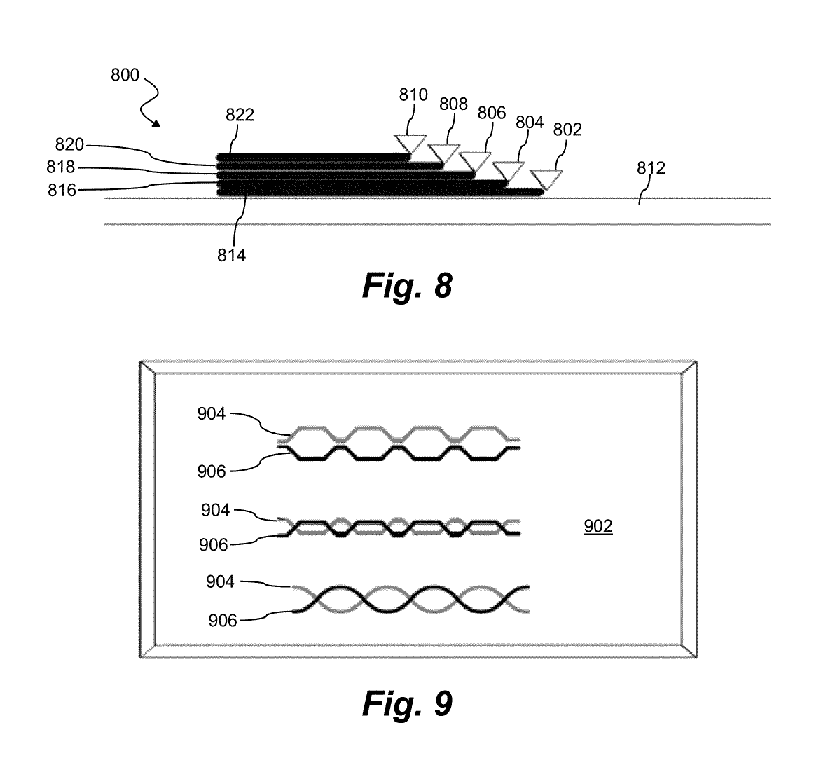

FIG. 8 shows a side view of a build plate with a plurality of feedpaths. Specifically, FIG. 8 includes a system 800 having a first extruder 802, a second extruder 804, a third extruder 806, a fourth extruder 808, and a fifth extruder 810, where each is depositing a layer of build material along a different z-axis position above the build plate 812. Using a plurality of extruders in this fashion can allow for layered building as shown in the figure. For example, in one aspect, the first extruder 802 deposits a first layer 814 of build material, the second extruder 804 deposits a second layer 816 of build material above the first layer 814, the third extruder 806 deposits a third layer 818 of build material above the second layer 816, the fourth extruder 808 deposits a fourth layer 820 of build material above the third layer 818, and the fifth extruder 810 deposits a fifth layer 822 of build material above the fourth layer 820. These layers may be deposited along feedpaths that are located directly above one another.

One skilled in the art will recognize that additional extruders may be usefully added, e.g., to further increase the aggregate volume deposition rate in a three-dimensional fabrication process. Similarly, one skilled in the art will recognize that extruders may be subtracted from the system 800, e.g., to decrease the size and simplify the configuration of the mechanical substructure. It will further be appreciated that the separate layers may employ simple line following, so that one layer is deposited directly above the preceding layer, or the separate layers may follow different paths, provided that each layer has sufficient underlying support to satisfy any design/fabrication rules for the material(s) being used.

FIG. 9 shows a top view of a build plate with a plurality of feedpaths. Specifically, the build plate 902 shows a plurality of build patterns including a plurality of feedpaths made possible by the devices, systems, and methods contemplated herein. These feedpaths may be created using an extruder assembly with multiple, independently movable extruders that allow for the concurrent extrusion of different feedpaths. As shown in the figure, the build patterns may include a first feedpath 904 and a second feedpath 906, although more or less feedpaths are of course possible.

The first feedpath 904 may be deposited by a first extruder, and the second feedpath 906 may be deposited by a second extruder. The first feedpath 904 and a second feedpath 906 may be created at different z-axis positions or at the same z-axis position as one another. In one aspect, when nozzles of a plurality of movable extruders in an extruder assembly are all at the same z-axis position, the feedpaths may be deposited next to each other at the same time. This can allow for the fabrication of intricate designs, e.g., for complex infill patters without slowing the fabrication process.

The fabrication processes described herein may include fabrication of an object based on a three-dimensional model obtained from a gaming (e.g., video game or the like) environment. The fabrication processes described herein may also or instead include fabrication of a three-dimensional coupon.

The above systems, devices, methods, processes, and the like may be realized in hardware, software, or any combination of these suitable for a particular application. The hardware may include a general-purpose computer and/or dedicated computing device. This includes realization in one or more microprocessors, microcontrollers, embedded microcontrollers, programmable digital signal processors or other programmable devices or processing circuitry, along with internal and/or external memory. This may also, or instead, include one or more application specific integrated circuits, programmable gate arrays, programmable array logic components, or any other device or devices that may be configured to process electronic signals. It will further be appreciated that a realization of the processes or devices described above may include computer-executable code created using a structured programming language such as C, an object oriented programming language such as C++, or any other high-level or low-level programming language (including assembly languages, hardware description languages, and database programming languages and technologies) that may be stored, compiled or interpreted to run on one of the above devices, as well as heterogeneous combinations of processors, processor architectures, or combinations of different hardware and software. In another aspect, the methods may be embodied in systems that perform the steps thereof, and may be distributed across devices in a number of ways. At the same time, processing may be distributed across devices such as the various systems described above, or all of the functionality may be integrated into a dedicated, standalone device or other hardware. In another aspect, means for performing the steps associated with the processes described above may include any of the hardware and/or software described above. All such permutations and combinations are intended to fall within the scope of the present disclosure.

Embodiments disclosed herein may include computer program products comprising computer-executable code or computer-usable code that, when executing on one or more computing devices, performs any and/or all of the steps thereof. The code may be stored in a non-transitory fashion in a computer memory, which may be a memory from which the program executes (such as random access memory associated with a processor), or a storage device such as a disk drive, flash memory or any other optical, electromagnetic, magnetic, infrared or other device or combination of devices. In another aspect, any of the systems and methods described above may be embodied in any suitable transmission or propagation medium carrying computer-executable code and/or any inputs or outputs from same.

It will be appreciated that the devices, systems, and methods described above are set forth by way of example and not of limitation. Absent an explicit indication to the contrary, the disclosed steps may be modified, supplemented, omitted, and/or re-ordered without departing from the scope of this disclosure. Numerous variations, additions, omissions, and other modifications will be apparent to one of ordinary skill in the art. In addition, the order or presentation of method steps in the description and drawings above is not intended to require this order of performing the recited steps unless a particular order is expressly required or otherwise clear from the context.

The method steps of the implementations described herein are intended to include any suitable method of causing such method steps to be performed, consistent with the patentability of the following claims, unless a different meaning is expressly provided or otherwise clear from the context. So for example performing the step of X includes any suitable method for causing another party such as a remote user, a remote processing resource (e.g., a server or cloud computer) or a machine to perform the step of X. Similarly, performing steps X, Y and Z may include any method of directing or controlling any combination of such other individuals or resources to perform steps X, Y and Z to obtain the benefit of such steps. Thus method steps of the implementations described herein are intended to include any suitable method of causing one or more other parties or entities to perform the steps, consistent with the patentability of the following claims, unless a different meaning is expressly provided or otherwise clear from the context. Such parties or entities need not be under the direction or control of any other party or entity, and need not be located within a particular jurisdiction.

It should further be appreciated that the methods above are provided by way of example. Absent an explicit indication to the contrary, the disclosed steps may be modified, supplemented, omitted, and/or re-ordered without departing from the scope of this disclosure.

It will be appreciated that the methods and systems described above are set forth by way of example and not of limitation. Numerous variations, additions, omissions, and other modifications will be apparent to one of ordinary skill in the art. In addition, the order or presentation of method steps in the description and drawings above is not intended to require this order of performing the recited steps unless a particular order is expressly required or otherwise clear from the context. Thus, while particular embodiments have been shown and described, it will be apparent to those skilled in the art that various changes and modifications in form and details may be made therein without departing from the spirit and scope of this disclosure and are intended to form a part of the invention as defined by the following claims, which are to be interpreted in the broadest sense allowable by law.

1. A device comprising:
a build volume having an x-axis, a y-axis, and a z-axis;
a first extruder configured to extrude a first build material;
a positioning system configured to move the first extruder in a path through the build volume during a three-dimensional fabrication process; and
a second extruder configured to extrude a second build material concurrently with the first extruder, the second extruder movable about the first extruder in an x-y plane of the build volume.

2. The device of claim 1 further comprising a controller programmed to control operation of the first extruder, the second extruder, and the positioning system in the three-dimensional fabrication process.

3. The device of claim 2 wherein the controller is configured to move the second extruder relative to the first extruder in the x-y plane according to the path of the three-dimensional fabrication process.

4. The device of claim 2 wherein the controller is programmed to avoid entanglement along feedpaths of the first extruder and the second extruder.

5. The device of claim 1 further comprising a processor configured to generate a path for fabricating an object in the build volume using the first extruder and the second extruder.

6. The device of claim 5 wherein the second extruder can move in the z-axis relative to the first extruder under control of a controller, wherein the processor receives a manual user specification of a z-axis offset for the second extruder relative to the first extruder.

7. The device of claim 5 wherein the second extruder can move in the z-axis relative to the first extruder under control of a controller, wherein the processor automatically determines a z-axis offset for the second extruder relative to the first extruder.

8. The device of claim 1 wherein the second extruder has a fixed z-axis position within the build volume relative to the first extruder.

9. The device of claim 8 wherein the fixed z-axis position is equal to a second z-axis position of the first extruder.

10. The device of claim 8 wherein the fixed z-axis position is different than a second z-axis position of the first extruder.

11. The device of claim 10 wherein the fixed z-axis position is above the second z-axis position in the build volume.

12. The device of claim 1 wherein the second extruder has a variable z-axis position within the build volume relative to the first extruder.

13. The device of claim 1 wherein the second extruder is radially movable at a fixed distance about the first extruder.

14. The device of claim 1 further comprising a third extruder configured to extruder a third build material concurrently with at least one of the first extruder and the second extruder, the third extruder movable within the x-y plane relative to the first extruder.

15. The device of claim 14 wherein the third extruder has a fixed z-axis position within the build volume relative to the first extruder.

16. The device of claim 14 wherein the third extruder has a variable z-axis position within the build volume relative to the first extruder.

17. The device of claim 14 wherein the third extruder is radially movable at a fixed distance about the first extruder.

18. The device of claim 14 wherein the third extruder is movable relative to the second extruder.

19. The device of claim 14 wherein the first extruder, second extruder, and third extruder can each extrude material independently from one another.

20. The device of claim 1 further comprising a first supply of the first build material, the first supply coupled to the first extruder.

21-40. (canceled)
